(19) United States
(12) Patent Application Publication
(10) Pub. No.: US 2024/0077596 A1
(43) Pub. Date: Mar. 7, 2024

(54) DISTANCE MEASURING METHOD, DISTANCE MEASURING APPARATUS, ELECTRONIC DEVICE, AND NON-TRANSITORY COMPUTER READABLE STORAGE MEDIUM

(71) Applicant: GUANGDONG OPPO MOBILE TELECOMMUNICATIONS CORP., LTD., Dongguan (CN)

(72) Inventor: Zewei WANG, Dongguan (CN)

(73) Assignee: GUANGDONG OPPO MOBILE TELECOMMUNICATIONS CORP., LTD., Dongguan (CN)

(21) Appl. No.: 18/506,740

(22) Filed: Nov. 10, 2023

Related U.S. Application Data
(63) Continuation of application No. PCT/CN2022/086873, filed on Apr. 14, 2022.

(30) Foreign Application Priority Data
Jun. 18, 2021 (CN) 202110675639.X

(51) Int. Cl. G01S 11/06

(52) U.S. Cl. CPC G01S 11/06

(57) ABSTRACT

A distance measuring method is applied to measure a distance between a first device and a second device. The first device and the second device include a UWB antenna module. The distance measuring method includes: obtaining the distance between the first device and the second device as an initial distance value; obtaining an actual distance between the first device and the second device according to a first distance measuring mode in response to the initial distance value being in a first distance range; and obtaining the actual distance between the first device and the second device according to a second distance measuring mode in response to the initial distance value being in a second distance range. The second distance measuring mode and the first distance measuring mode are configured to obtain the actual distance between the first device and the second device based on the UWB antenna module.

### CROSS-REFERENCE TO RELATED DISCLOSURES

The present application is a continuation of International Patent Application No. PCT/CN2022/086873, filed on Apr. 14, 2022, which claims priority to Chinese Patent Application No. 202110675639.X, entitled “DISTANCE MEASURING METHOD, DISTANCE MEASURING APPARATUS, ELECTRONIC DEVICE, AND NON-TRANSITORY COMPUTER READABLE STORAGE MEDIUM”, filed on Jun. 18, 2021, which is herein incorporated by reference in its entirety.

### TECHNICAL FIELD

The present disclosure relates to the technical field of mobile communication, and in particular to a distance measuring method, a distance measuring apparatus, an electronic device, and a non-transitory computer readable storage medium.

### BACKGROUND

Bluetooth Low Energy (BLE) is a wireless communication technology, and is generally applied in a distance measuring scenario, because power consumption of a BLE technology is low. However, accuracy of the distance measuring performed by using the BLE technology is low. In a scenario in which closer distance measuring is performed, an Ultra Wide Band (UWB) technology is generally adopted for measuring a closer distance. However, power consumption of the UWB technology is higher than that of the BLE technology, which is not beneficial to prolong a cruising duration of a device.

### SUMMARY OF THE DISCLOSURE

The embodiments of the present disclosure provide a distance measuring method, a distance measuring device, an electronic device, and a non-transitory computer readable storage medium.

In a first aspect, an embodiment of the present disclosure provides a distance measuring method. The distance measuring method is applied to measure a distance between a first device and a second device, and each of the first device and the second device includes a UWB antenna module. The distance measuring method includes: obtaining the distance between the first device and the second device as an initial distance value; obtaining an actual distance between the first device and the second device according to a first distance measuring mode in response to the initial distance value being in a first distance range; and obtaining the actual distance between the first device and the second device according to a second distance measuring mode in response to the initial distance value being in a second distance range. The second distance measuring mode and the first distance measuring mode are configured to obtain the actual distance between the first device and the second device based on the UWB antenna module. Power consumption of the second distance measuring mode is lower than that of the first distance measuring mode, and no intersection exist between the second distance range and the first distance range.

In a second aspect, an embodiment of the present disclosure further provides an electronic device. The electronic device includes a memory and a processor. The memory stores program instructions. The processor is configured to perform the distance measuring method in response to executing the program instructions by the processor. The distance measuring method includes: obtaining the distance between the first device and the second device as an initial distance value; obtaining an actual distance between the first device and the second device according to a first distance measuring mode in response to the initial distance value being in a first distance range; and obtaining the actual distance between the first device and the second device according to a second distance measuring mode in response to the initial distance value being in a second distance range. In the second distance measuring mode and the first distance measuring mode, the distance between the first device and the second device is obtained as the actual distance based on the UWB antenna module. Power consumption of the second distance measuring mode is lower than that of the first distance measuring mode, and no intersection exist between the second distance range and the first distance range.

In a third aspect, an embodiment of the present disclosure further provides a non-transitory computer readable storage medium. A program code is stored in the non-transitory computer readable storage medium. The program code is configured to be called by a processor to execute the distance measuring method. The distance measuring method includes: obtaining the distance between the first device and the second device as an initial distance value; obtaining an actual distance between the first device and the second device according to a first distance measuring mode in response to the initial distance value being in a first distance range; and obtaining the actual distance between the first device and the second device according to a second distance measuring mode in response to the initial distance value being in a second distance range. In the second distance measuring mode and the first distance measuring mode, the distance between the first device and the second device is obtained as the actual distance based on the UWB antenna module. Power consumption of the second distance measuring mode is lower than that of the first distance measuring mode, and no intersection exist between the second distance range and the first distance range.

### BRIEF DESCRIPTION OF THE DRAWINGS

In order to more clearly illustrate the technical solutions of the present disclosure, hereinafter, a brief introduction will be given to the accompanying drawings that are used in some embodiments. Obviously, the accompanying drawings in the description below are merely some embodiments of the present disclosure. For those of ordinary skill in the art, other accompanying drawings may be obtained based on these accompanying drawings without any creative efforts.

FIG. 1 is a schematic view of a hardware environment in which a distance measuring method in some embodiments of the present disclosure.

FIG. 2 is a schematic flowchart of a distance measuring method in some embodiments of the present disclosure.

FIG. 3 is a schematic flowchart of a distance measuring method in some embodiments of the present disclosure.

FIG. 4 is a schematic flowchart of a distance measuring method in some embodiments of the present disclosure.

FIG. 5 is a schematic flowchart of a distance measuring method in some embodiments of the present disclosure.

FIG. 6 is a schematic view illustrating signal interaction between a first UWB antenna module and a second UWB antenna module in a distance measuring method in some embodiments of the present disclosure.

FIG. 7 is a schematic flowchart of a distance measuring method in some embodiments of the present disclosure.

FIG. 8 is a schematic flowchart of a distance measuring method in some embodiments of the present disclosure.

FIG. 9 is a schematic flowchart of a distance measuring method in some embodiments of the present disclosure.

FIG. 10 is a schematic flowchart of a distance measuring method in some embodiments of the present disclosure.

FIG. 11 is a schematic flowchart of a distance measuring method in some embodiments of the present disclosure.

FIG. 12 is a block schematic view of a distance measuring apparatus in some embodiments of the present disclosure.

FIG. 13 is a block schematic view of an electronic device in some embodiments of the present disclosure.

FIG. 14 is a block schematic view of a non-transitory computer readable storage medium in some embodiments of the present disclosure.

### DETAILED DESCRIPTION

The technical solutions in some embodiments of the present disclosure may be clearly and completely described in conjunction with accompanying drawings in some embodiments of the present disclosure. Obviously, the described embodiments are only a part of the embodiments of the present disclosure, and not all embodiments. Based on the embodiments in the present disclosure, all other embodiments obtained by those of ordinary skill in the art without creative effort are in the scope of the present disclosure.

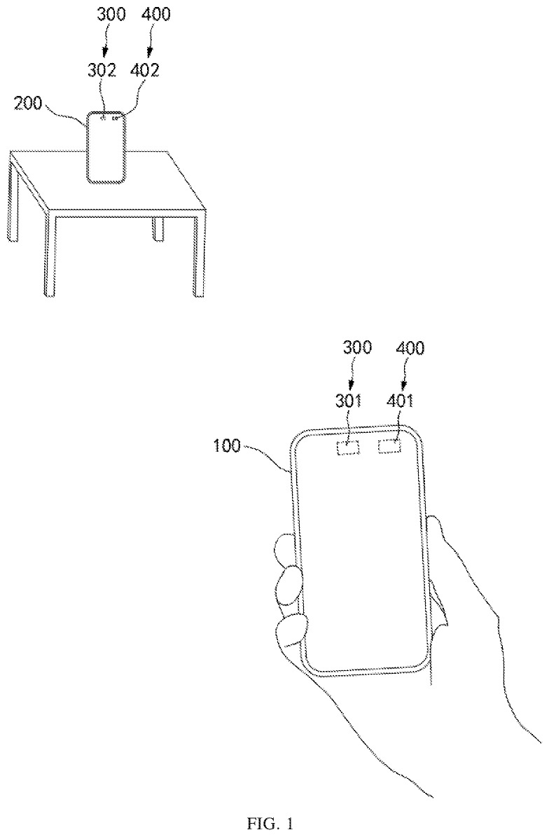

As illustrated in FIG. 1. FIG. 1 is a schematic view of a hardware environment in which a distance measuring method in some embodiments of the present disclosure. The distance measuring method is applied to measure a distance between a first device 100 and a second device 200.

The first device 100 may be a smart home device, such as a television, an electric lamp, an air conditioner, a refrigerator, a smart switch, a door lock, an alarm, a smart socket, a sweeping robot, a sound box, a smart tag, or the like. The first device 100 may also be a mobile terminal, such as a mobile phone, a tablet computer, a smart watch, or a pair of smart glasses. The first device 100 may also be other types of smart devices. The second device 200 may be the above-mentioned exemplary smart home device, the mobile terminal, other types of smart devices, or the like. The second device 200 and the first device 100 may be the same type of device, or may be different types of devices.

The first device 100 and the second device 200 may include a Bluetooth module 300, and the first device 100 and the second device 200 may perform signal interaction through the Bluetooth module 300. The first device 100 and the second device 200 may further include an Ultra Wide Band (UWB) antenna module 400, and the first device 100 and the second device 200 may further perform the signal interaction through the UWB antenna module 400.

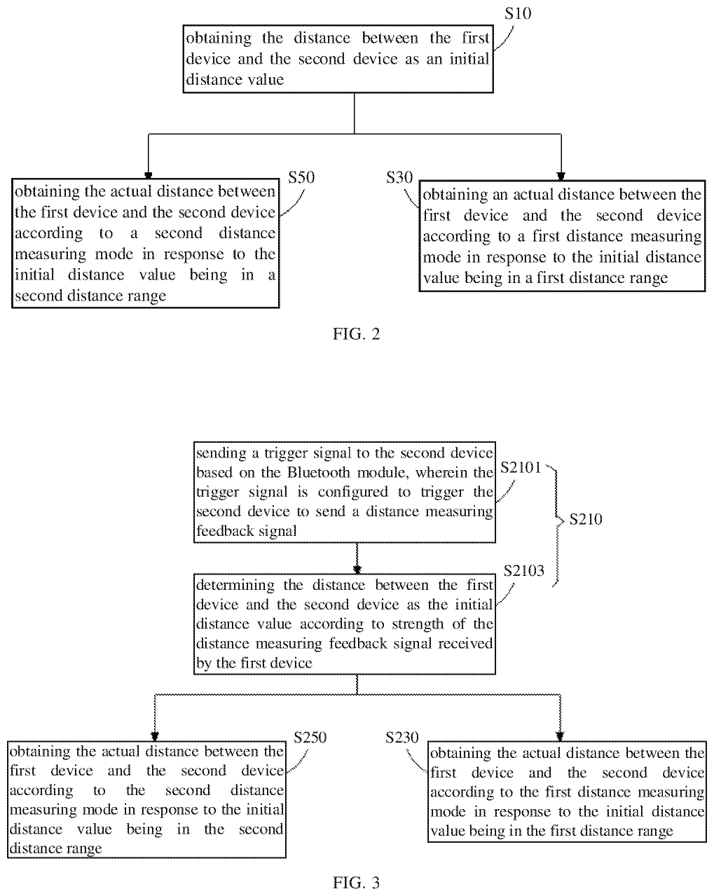

As illustrated in FIG. 2, in some embodiments, the distance measuring method provided by the embodiments of the present disclosure is configured to obtain the distance between the first device 100 and the second device 200 based on the above-mentioned UWB antenna module 400. The distance measuring method may include an operation S10, an operation S30, and an operation S50.

At the operation S10, the distance measuring method may include obtaining the distance between the first device 100 and the second device 200 as an initial distance value.

The initial distance value may be obtained according to a signal transmitted between the first device 100 and the second device 200. For example, the transmitted signal may be a Bluetooth signal, a UWB signal, a Zigbee signal, a long-term evolution signal, a wireless fidelity signal, a 5G signal, or the like. The initial distance value may also be obtained according to a third-party distance measuring device measuring the distance between the first device 100 and the second device 200.

For example, the initial distance value may be obtained based on the Bluetooth signal transmitted by a Bluetooth module 300. That is, the distance between the first device 100 and the second device 200 is obtained based on the Bluetooth module 300 and used as the initial distance value. For example, the initial distance value may be obtained based on the UWB signal transmitted by the UWB antenna module 400. That is, the distance between the first device 100 and the second device 200 is obtained based on the UWB antenna module 400 and used as the initial distance value. Further, the initial distance value between the first device 100 and the second device 200 may be obtained based on strength of the signal transmitted between the first device 100 and the second device 200.

At the operation S30, the distance measuring method may include obtaining an actual distance between the first device 100 and the second device 200 according to a first distance measuring mode in response to the initial distance value being in a first distance range.

The first distance range may be set based on a specific distance measuring application. For example, the first distance range may be [0, 1) m, that is, a distance in the first distance range is greater than or equal to 0 and less than 1 meter. The first distance range may be adjusted according to the first distance measuring mode.

In the first distance measuring mode, an actual distance between the first device 100 and the second device 200 is obtained based on the UWB antenna module 400. That is, in the first distance measuring mode, the first device 100 and the second device 200 obtain the actual distance between the first device 100 and the second device 200 based on their respective UWB antenna modules 400. In the foregoing operations, the Bluetooth module 300 is configured to perform one-time distance measuring to obtain the initial distance value. In response to the initial distance value being in the first distance range, the UWB antenna module 400 is configured to perform secondary distance measuring. Compared with the distance measuring performed by the Bluetooth module 300, the distance measuring performed by the UWB antenna module 400 has the advantages that the anti-interference capability is stronger, and the accuracy of the obtained actual distance is higher.

For illustrative purposes, the UWB antenna module 400 of the first device 100 may be referred to as a first UWB antenna module 401, and the UWB antenna module 400 of the second device 200 may be referred to as a second UWB antenna module 402.

In the embodiments of the present disclosure, the first UWB antenna module 401 may have an operating state and a non-operating state. In response to the first UWB antenna module 401 being in the operating state, a transmitting terminal of the first UWB antenna module 401 may send out the UWB signal, and a receiving terminal of the first UWB antenna module 401 may receive the UWB signal. Power of the first UWB antenna module 401 in the non-operating state is less than power of the first UWB antenna module 401 in the operating state. In response to the first UWB antenna module 401 being in the non-operating state, the first UWB antenna module 401 may not transmit or send data, for example, the first UWB antenna module 401 is standby or turned off.

The second UWB antenna module 402 may have an operating state and a non-operating state. A state of the second UWB antenna module 402 is approximately the same as a state of the first UWB antenna module 401. In response to the second UWB antenna module 402 being in the operating state, a transmitting terminal of the second UWB antenna module 402 may send out the UWB signal, and a receiving terminal of the second UWB antenna module 402 may receive the UWB signal. Power of the second UWB antenna module 402 in the non-operating state is less than power of the second UWB antenna module 402 in the operating state. In response to the second UWB antenna module 402 being in the non-operating state, the second UWB antenna module 402 may not transmit or send the data, for example, the second UWB antenna module 402 is standby or turned off.

The first UWB antenna module 401 and the second UWB antenna module 402 may perform signal interaction to measure the actual distance between the first device 100 and the second device 200. For example, the actual distance between the first device 100 and the second device 200 may be measured according to time-of-fly (TOF) of the signal. Alternatively, the actual distance between the first device 100 and the second device 200 may be measured according to a Received Signal Strength Indication (RSSI).

In an application scenario of the operation S30, for example, in the case that a distance in the first distance range is greater than or equal to 0 and less than 1 meter, in response to the initial distance value obtained by performing the one-time distance measuring with the Bluetooth module 300 being 0.5 meter, due to 0<0.5<1 meter, the actual distance between the first device 100 and the second device 200 is obtained according to the first distance measuring mode. Compared with the distance measuring performed by the Bluetooth module 300, the distance measuring performed by the UWB antenna module 400 has the advantages that the anti-interference capability is stronger, and the accuracy of the obtained actual distance is higher. Thus, it is possible that the actual distance obtained according to the first distance measuring mode is 0.68 meter, so that the obtained actual distance is more accurate, which helps a user to find a small object through the distance measuring method. After the actual distance is obtained according to the first distance measuring mode, the obtained actual distance may be stored or fed back to a data acquisition party, such as feedback to a display screen to display.

At the operation S50, the distance measuring method may include obtaining the actual distance between the first device 100 and the second device 200 according to a second distance measuring mode in response to the initial distance value being in a second distance range.

The second distance range may be set based on the specific distance measuring application. There is no intersection between the first distance range and the second distance range. For example, in the embodiments of the present disclosure, a lower limit value of the second distance range may be greater than an upper limit value of the first distance range. For example, the second distance range may be [1, 3) meters. That is, a distance in the second distance range is greater than or equal to 1 meter and less than 3 meters. For example, the second distance range may be (1, 3) meters. For example, the second distance range may be (1, 3] meters. For example, the second distance range may be [1, 3] meters. The second distance range may be adjusted according to the second distance measuring mode. Alternatively, in some embodiments, a distance in the second distance range may be greater than or equal to 1 meter, which means that the second distance measuring mode may be configured for distance measuring under the distance measuring requirement of greater than 1 meter.

The second distance measuring mode is that the actual distance between the first device 100 and the second device 200 is obtained based on the UWB antenna module 400. Power consumption of the second distance measuring mode is lower than power consumption of the first distance measuring mode. Thus, different distance measuring modes may be used in different distance ranges based on the initial distance value, making a mode configured for secondary distance measuring more flexible. In the second distance measuring mode, the first UWB antenna module 401 and the second UWB antenna module 402 may measure the actual distance between the first device 100 and the second device 200 according to the RSSI of the signal transmitted between the first UWB antenna module 401 and the second UWB antenna module 402.

In the foregoing operations, the Bluetooth module 300 is configured to perform the one-time distance measuring to obtain the initial distance value. Because the initial distance value is in the second distance range, the UWB antenna module 400 is configured to perform the secondary distance measuring. Compared with the distance measuring performed by the Bluetooth module 300, the distance measuring performed by the UWB antenna module 400 has the advantages that the anti-interference capability is stronger, and the accuracy of the obtained actual distance is higher.

In an application scenario of the operation S50, for example, in the case that a distance in the first distance range is less than 1 meter, and a distance in the second distance range is greater than or equal to 1 meter and less than 3 meters, in response to the initial distance value obtained by performing the one-time distance measuring with the Bluetooth module 300 being 2 meters, due to 1<2<3 meters, the actual distance between the first device 100 and the second device 200 is obtained according to the second distance measuring mode. Compared with the distance measuring performed by the Bluetooth module 300, the distance measuring performed by the UWB antenna module 400 has the advantages that the anti-interference capability is stronger, and the accuracy of the obtained actual distance is higher. And the higher the accuracy, the larger the power consumption is. Thus, the second distance measuring mode instead of the first distance measuring mode is configured for measuring the distance, so that lower power consumption and higher accuracy may be achieved at the same time. After the actual distance is obtained according to the second distance measuring mode, the obtained distance may be stored or fed back to the data acquisition party, such as, feedback to the display screen to display.

The distance measuring method provided by the embodiments of the present disclosure is configured to measure the distance between the first device 100 and the second device 200. Each of the first device 100 and the second device 200 includes the UWB antenna module 400. In response to the initial distance value being in the first distance range, the actual distance between the first device 100 and the second device 200 is obtained according to the first distance measuring mode. In response to the initial distance value being in the second distance range, the actual distance between the first device 100 and the second device 200 is obtained according to the second distance measuring mode. In both the second distance measuring mode and the first distance measuring mode, the distance between the first device 100 and the second device 200 is obtained based on the UWB antenna module 400, which helps to perform the secondary distance measuring through the UWB antenna module 400. Compared with the distance measuring performed by the Bluetooth module 300, the distance measuring performed by the UWB antenna module 400 has the advantages that the anti-interference capability is stronger, and the accuracy of the obtained actual distance is higher. The power consumption of the second distance measuring mode is lower than the power consumption of the first distance measuring mode, and the second distance range has no intersection with the first distance range, which helps to adopt different distance measuring modes in different distance ranges according to the initial distance value. Thus, the mode adopted by the secondary distance measuring is more flexible.

Based on the first device 100, the second device 200 and the distance measuring method provided by the above embodiments, the embodiment of the present disclosure further provides another distance measuring method. As illustrated in FIG. 3, the distance measuring method may include an operation S210, an operation S230, and an operation S250. The distance measuring method of the present embodiment has the same or corresponding implementation operations as those of the foregoing embodiments. For specific explanation of these same or corresponding implementation operations, reference may be made to the contents provided by the foregoing embodiments, which is not be repeated in the present embodiment.

At the operation S210, the distance measuring method may include obtaining the distance between the first device 100 and the second device 200 as the initial distance value.

The initial distance value may be obtained based on the signal transmitted between the first device 100 and the second device 200. A type of the transmitted signal is not limited, for example, the transmitted signal may be the Bluetooth signal or the UWB signal.

In some embodiments, the initial distance value may be obtained based on the Bluetooth signal transmitted by the Bluetooth module 300. For illustrative purposes, the Bluetooth module 300 of the first device 100 is referred to as a first Bluetooth module 301, and the Bluetooth module 300 of the second device 200 is referred to as a second Bluetooth module 302. The first Bluetooth module 301 and the second Bluetooth module 302 may adopt Bluetooth Low Energy (BLE) technology for distance measuring.

The first Bluetooth module 301 may have an operating state and a non-operating state. The operating state may include a broadcasting state, a scanning state, or the like. In response to the first Bluetooth module 301 being in the broadcasting state, the first Bluetooth module 301 may transmit a Beacon signal to surrounding devices at fixed time intervals, which helps the first Bluetooth module 301 to establish connection with the Bluetooth module 300 in the scanning state. The first Bluetooth module 301 may actively look for a device sending out the Beacon signal in response to the first Bluetooth module 301 being in the scanning state, which helps the first Bluetooth module 301 to establish connection with the Bluetooth module 300 in the broadcasting state.

Power of the first Bluetooth module 301 in the non-operating state is less than power of the first Bluetooth module 301 in the operating state. The first Bluetooth module 301 may not transmit or send the data in response to the first Bluetooth module 301 being in the non-operating state, for example, the first Bluetooth module 301 is standby or turned off.

The second Bluetooth module 302 may have an operating state and a non-operating state. A state of the second Bluetooth module 302 is approximately the same as a state of the first Bluetooth module 301. The operating state of the second Bluetooth module 302 may include the broadcasting state, the scanning state, or the like. In response to the second Bluetooth module 302 being in the broadcasting state, the second Bluetooth module 302 may transmit the Beacon signal to the surrounding devices at fixed time intervals, which helps the second Bluetooth module 302 to establish connection with the Bluetooth module 300 in the scanning state. In response to the second Bluetooth module 302 being in the scanning state, the second Bluetooth module 302 may actively look for the device sending out the Beacon signal, which helps the second Bluetooth module 302 to establish connection with the Bluetooth module 300 in the broadcasting state. Power of the second Bluetooth module 302 is in the non-operating state is less than power of the second Bluetooth module 302 in the operating state. In response to the second Bluetooth module 302 being in the non-operating state, the second Bluetooth module 302 may not transmit or send the data, for example, the second Bluetooth module 302 is standby or turned off.

One of the first Bluetooth module 301 and the second Bluetooth module 302 may be in the broadcasting state, and the other one of the first Bluetooth module 301 and the second Bluetooth module 302 may be in the scanning state. Thus, the signal interaction between the first Bluetooth module 301 and the second Bluetooth module 302 may be achieved, and the distance between the first device 100 and the second device 200 may be measured to serve as an initial distance. Compared with the method that the initial distance value is obtained through the UWB antenna module 400, the method that the initial distance value is obtained through the Bluetooth module 300 is beneficial to reduce the power consumption of the device and prolong a cruising duration of the device.

Based on the first Bluetooth module 301 and the second Bluetooth module 302 described above, the first device 100 and the second device 200 may perform Bluetooth signal transmission with each other to obtain the initial distance between the first device 100 and the second device 200. As illustrated in FIG. 3, in some embodiments, the operation S210 may include an operation S2101 and an operation S2103.

At the operation S2101, the distance measuring method may include sending a trigger signal to the second device 200 based on the Bluetooth module 300, wherein the trigger signal is configured to trigger the second device 200 to send a distance measuring feedback signal.

In some embodiments, the trigger signal of the first device 100 may be transmitted based on the Bluetooth module 300, and the distance measuring feedback signal of the second device 200 may also be transmitted based on the Bluetooth module 300. For example, the first device 100 may utilize the first Bluetooth module 301 to send the trigger signal to the second Bluetooth module 302 of the second device 200, and after receiving the trigger signal, the second Bluetooth module 302 may utilize the second Bluetooth module 302 to send the distance measuring feedback signal to the first Bluetooth module 301 of the first device 100. For example, the first Bluetooth module 301 may be in the broadcasting state, and the second Bluetooth module 302 may be in the scanning state. The trigger signal sent by the first Bluetooth module 301 may be the Beacon signal, and the second Bluetooth module 302 sends the distance measuring feedback signal to the first Bluetooth module 301 after scanning the Beacon signal. The distance measuring feedback signal may carry power information of the Beacon signal sent by a transmitting terminal of the second Bluetooth module 302.

At the operation S2103, the distance measuring method may include determining the distance between the first device 100 and the second device 200 as the initial distance value according to strength of the distance measuring feedback signal received by the first device 100.

The first device 100 may utilize the first Bluetooth module 301 to receive the distance measuring feedback signal. The first Bluetooth module 301 may parse out the strength of the received distance measuring feedback signal, i.e., the Received Signal Strength Indication (RSSI), from the distance measuring feedback signal, and parse out the power information P_{TX} of the transmitting terminal of the second Bluetooth module 302.

A distance D between the first device 100 and the second device 200 may be calculated by a first calculation formula and a second calculation formula.

L_{S}=32.45+20 log₁₀(f_{MHz})+20 log₁₀(D). The first calculation formula:

P_{RSSI}=P_{TX}−L_{S}. The second calculation formula:

In the first calculation formula and the second calculation formula, L_{S} represents loss value (dB) of free space, f_{MHz} represents frequency at which the Bluetooth signal operates, P_{RSSI} represents RSSI.

The Bluetooth signal operates in a 2.4 GHz frequency band. Compared with the UWB signal, the space energy attenuation of the Bluetooth signal is smaller, the transmission distance is farther, and the power consumption of the Bluetooth module 300 for transceiving the Bluetooth signal is lower. Thus, distance measuring performed according to the Bluetooth RSSI manner is helpful in quickly obtaining the initial distance value.

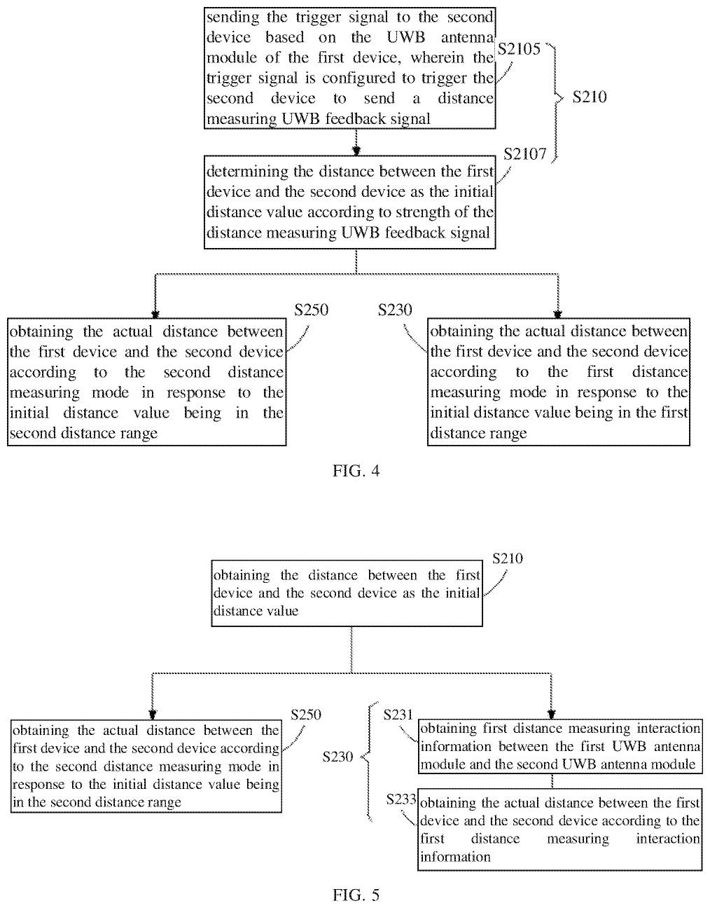

As illustrated in FIG. 4, in some embodiments, the initial distance value may be obtained based on the UWB signal sent by the UWB antenna module 400. For example, the initial distance value may be obtained based on the UWB antenna module 400, that is, the distance between the first device 100 and the second device 200 is obtained based on the UWB antenna module 400 and used as the initial distance value. Thus, the operation S210 may include an operation S2105 and an operation S2107.

At the operation S2105, the distance measuring method may include sending the trigger signal to the second device 200 based on the UWB antenna module 400 of the first device 100, wherein the trigger signal is configured to trigger the second device 200 to send a distance measuring UWB feedback signal.

The first device 100 may utilize the first UWB antenna module 401 to send the trigger signal to the second UWB antenna module 402 of the second device 200. After receiving the trigger signal, the second device 200 may utilize the second UWB antenna module 402 to send the distance measuring UWB feedback signal to the first UWB antenna module 401 of the first device 100. The distance measuring UWB feedback signal may carry the power information of the UWB signal sent by the transmitting terminal of the second UWB antenna module 402.

At the operation S2107: the distance measuring method may include determining the distance between the first device 100 and the second device 200 as the initial distance value according to strength of the distance measuring UWB feedback signal.

The initial distance value may be obtained according to a third calculation formula and a fourth calculation formula.

L_{S}=32.45+20 log₁₀(f_{MHz})+20 log₁₀(D0_{Km}). The third calculation formula:

P_{RSSI}=P_{TX}−L_{S}. The fourth calculation formula:

In the third calculation formula and the fourth calculation formula, L_{S} represents the loss value (dB) of the free space, f_{MHz} represents frequency of operation, D0_{Km} represents the initial distance value, P_{RSSI} represents RSSI, and P_{TX} represents the power information.

Seen from the above interaction flow, the transmitting terminal of the first UWB antenna module 401 does not operate, while the receiving terminal of the first UWB antenna module 401 operates, which helps to omit the power consumption of the transmitting terminal of the first UWB antenna module 401. The transmitting terminal of the second UWB antenna module 402 operates, while the receiving terminal of the second UWB antenna module 402 does not operate, which helps to omit the power consumption of the receiving terminal of the second UWB antenna module 402. Compared with using the Bluetooth module 300 to obtain the initial distance value, using the UWB antenna module 400 to obtain the initial distance value may greatly reduce the power consumption of the device. In the present embodiment, because the UWB antenna module 400 has stronger anti-interference capability, compared with using the Bluetooth module 300 to obtain the initial distance value, using the UWB antenna module 400 to obtain the initial distance value has higher accuracy.

In some embodiments, the trigger signal of the first device 100 may be transmitted based on the UWB antenna module 400, and the distance measuring feedback signal of the second device 200 may also be transmitted based on the UWB antenna module 400. Alternatively, the trigger signal of the first device 100 may be transmitted based on the Bluetooth module 300, and the distance measuring feedback signal of the second device 200 may also be transmitted based on the UWB antenna module 400. Alternatively, the trigger signal of the first device 100 may be transmitted based on the UWB antenna module 400, the distance measuring feedback signal of the second device 200 may also be transmitted based on the Bluetooth module 300. In the embodiments of the present disclosure, in response to obtaining the initial distance value between the first device 100 and the second device 200, the type of the signal transmitted between the first device 100 and the second device 200 is not limited, as long as it is ensured that the first device 100 may trigger the second device 200 to send the distance measuring feedback signal.

At the operation S230, the distance measuring method may include obtaining the actual distance between the first device 100 and the second device 200 according to the first distance measuring mode in response to the initial distance value being in the first distance range.

In the present embodiment, the implementation of the operation S230 may refer to the above operation S30, which is not be repeated in the present embodiment. In the present embodiment, based on the first distance measuring mode, a first UWB antenna module 401 of the first device 100 and a second UWB antenna module 402 of the second device 200 may perform the signal interaction to measure the distance between the first device 100 and the second device 200. For example, based on the first distance measuring mode, the actual distance between the first device 100 and the second device 200 may be measured according to the time-of-fly (TOF) of the signal.

As illustrated in FIG. 5, in order to obtain the actual distance between the first device 100 and the second device 200 according to the first distance measuring mode, the operation S230 may include an operation S231 and an operation S233.

At the operation S231, the distance measuring method may include obtaining first distance measuring interaction information between the first UWB antenna module 401 and the second UWB antenna module 402.

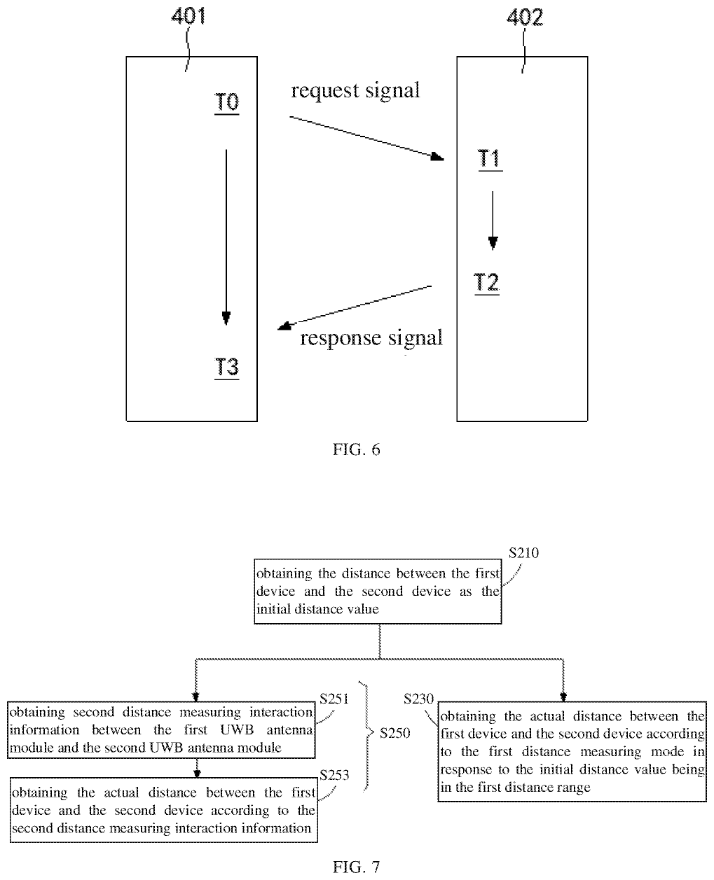

The first distance measuring interaction information may include time information of the UWB signal interaction between the first UWB antenna module 401 and the second UWB antenna module 402. As illustrated in FIG. 6, the time information may include the following time points. The first UWB antenna module 401 may send a request signal carrying time stamp information to the second UWB antenna module 402, and a time point for sending the request signal is recorded as TO. The second UWB antenna module 402 may be in a receiving state, after receiving the request signal of the first UWB antenna module 401, the second UWB antenna module 402 records a received time point T1. The second UWB antenna module 402 adds its own time stamp information and sends the time stamp information back to the first UWB antenna module 401, a sending time point is recorded as T2. After receiving the information carrying the time stamp sent by the second UWB antenna module 402, the first UWB antenna module 401 records a received time point T3.

Based on the embodiments of FIG. 6, in order to obtain the first distance measuring interaction information based on the first distance measuring mode, the operation S231 may include: controlling the first UWB antenna module 401 to send the distance measuring UWB signal, and obtaining sending time information of the distance measuring UWB signal; obtaining arrival time information of the distance measuring UWB signal to the second UWB antenna module 402; obtaining feedback time information of the feedback UWB signal sent by the second UWB antenna module 402 according to the distance measurement UWB signal; and obtaining receiving time information of the feedback UWB signal received by the first UWB antenna module 401.

At the operation S233, the distance measuring method may include obtaining the actual distance between the first device 100 and the second device 200 according to the first distance measuring interaction information.

In the present embodiment, based on the distance measuring time information, the arrival time information, the feedback time information, and the receiving time information, the actual distance between the first device 100 and the second device 200 is calculated. In some embodiments, the transmitting terminal of the first UWB antenna module 401 may transmit the distance measuring UWB signal, the receiving terminal of the second UWB antenna module 402 may receive the distance measuring UWB signal, the receiving terminal of the first UWB antenna module 401 may receive the feedback UWB signal, and the transmitting terminal of the second UWB antenna module 402 may transmit the feedback UWB signal.

The distance D between the first device 100 and the second device 200 may be calculated by a fifth calculation formula and a sixth calculation formula.

TOF=((T3−T0)−(T2−T1))/2. The fifth calculation formula:

D=c*TOF. The sixth calculation formula:

In the fifth calculation formula and the sixth calculation formula, c represents propagation speed of an electromagnetic wave (i.e., the UWB signal), TO represents the sending time information. T1 represents the arrival time information, T2 represents the feedback time information, and T3 represents the receiving time information.

Seen from the above interaction flow, both the transmitting terminal and the receiving terminal of the first UWB antenna module 401 operate, and both the transmitting terminal and the receiving terminal of the second UWB antenna module 402 also operate. It helps to improve the accuracy of the distance, and helps to apply the first distance measuring mode in a closer distance measuring scenario, such as, a scenario in which the first distance range is [0, 1) meter.

At the operation S250, the distance measuring method may include, obtaining the actual distance between the first device 100 and the second device 200 according to the second distance measuring mode in response to the initial distance value being in the second distance range.

In the present embodiment, the implementation of the operation S250 may refer to the above operation S50, which is not be repeated in the present embodiment.

In the present embodiment, the distance between the first device 100 and the second device 200 that is obtained by the second distance measuring mode based on the UWB antenna module 400 is used as the actual distance between the first device 100 and the second device 200. The power consumption of the second distance measuring mode is lower than the power consumption of the first distance measuring mode, which helps to adopt different distance measuring modes in different distance ranges according to the initial distance value, so that the mode adopted by the secondary distance measuring is more flexible. In the second distance measuring mode, the first UWB antenna module 401 and the second UWB antenna module 402 may measure the actual distance between the first device 100 and the second device 200 by RSSI.

As illustrated in FIG. 7, in order to obtain the actual distance between the first device 100 and the second device 200 according to the second distance measuring mode, the operation S250 may include an operation S251 and an operation S253.

At the operation S251, the distance measuring method may include obtaining second distance measuring interaction information between the first UWB antenna module 401 and the second UWB antenna module 402.

The second distance measuring interaction information may include strength information of the UWB signal between the first UWB antenna module 401 and the second UWB antenna module 402.

In some embodiments, in order to obtain the second distance measuring interaction information, the operation S251 may include: sending a mode determination instruction for triggering the second distance measuring mode to the second device 200; obtaining the power information of the distance measuring UWB signal sent by the second UWB antenna module 402 based on the mode determination instruction; and obtaining strength information of the distance measuring UWB signal received by the first UWB antenna module 401.

The mode determination instruction may be send based on the first UWB antenna module 401 switching to the second distance measuring mode, which facilitates fast switching of the second UWB antenna module 402 and adaptation of a current distance measuring mode of the first UWB antenna module 401. In some embodiments, the mode determination instruction may be sent by the first device 100 based on a Bluetooth communication connection or/and a UWB communication connection between the first device 100 and the second device 200. After the initial distance between the first device 100 and the second device 200 is determined, in response to the initial distance value falling in the second distance range, the first device 100 may be triggered to send the mode determination instruction for initiating the second distance measuring mode.

At the operation S253, the distance measuring method may include obtaining the actual distance between the first device 100 and the second device 200 according to the second distance measuring interaction information.

In the present embodiment, based on the power information and the strength information, the actual distance between the first device 100 and the second device 200 is calculated. In some embodiments, the transmitting terminal of the second UWB antenna module 402 may transmit the distance measuring UWB signal, and the receiving terminal of the first UWB antenna module 401 may receive the distance measuring UWB signal. The first UWB antenna module 401 may parse out the strength of the received distance measuring UWB signal, i.e., the Received Signal Strength Indication (RSSI), from the distance measuring UWB signal.

An actual distance D between the first device 100 and the second device 200 may be calculated by a seventh calculation formula and an eighth calculation formula.

L_{S}=32.45+20 log₁₀(f_{MHz})+20 log₁₀(D_{Km}). The seventh calculation formula:

P_{RSSI}=P_{TX}−L_{S}. The eighth calculation formula:

In the seventh calculation formula and the eighth calculation formula, L_{S} represents the loss value (dB) of the free space, f_{MHz} represents the frequency of operation, P_{RSSI} represents RSSI, and P_{TX} represents the power information.

Seen from the above interaction flow, the transmitting terminal of the first UWB antenna module 401 does not operate, while the receiving terminal of the first UWB antenna module 401 operates, which helps to omit the power consumption of the transmitting terminal of the first UWB antenna module 401. The transmitting terminal of the second UWB antenna module 402 operates, while the receiving terminal of the second UWB antenna module 402 does not operate, which helps to omit the power consumption of the receiving terminal of the second UWB antenna module 402. Compared with the first distance measuring mode, the second distance measuring mode may greatly reduce the power consumption of the device. The second distance measuring mode may be applied in a scenario of moderate distance measuring. For example, the UWB antenna module 400 is applied to the scenario that the second distance range is [1, 3] meters. In addition, because the UWB antenna module 400 does not adopt a carrier wave, but utilizes a non-sinusoidal wave narrow pulse transmission signal ranging from a nanosecond level to a microsecond level, compared with the Bluetooth module 300, the UWB antenna module 400 has stronger anti-interference and anti-multipath capabilities. In the case that a RSSI mode is adopted for distance measuring, the distance measured by the UWB antenna module 400 is more accurate.

In the distance measuring method provided in the present embodiment, the first distance measuring mode adopts the TOF mode of UWB for distance measuring, and the second distance measuring mode adopts the RSSI mode of UWB for distance measuring. It helps to effectively reduce the power consumption of the devices according to the actual distance between the first device 100 and the second device 200 obtained by the second distance measuring mode in response to the initial distance value being in the second distance range.

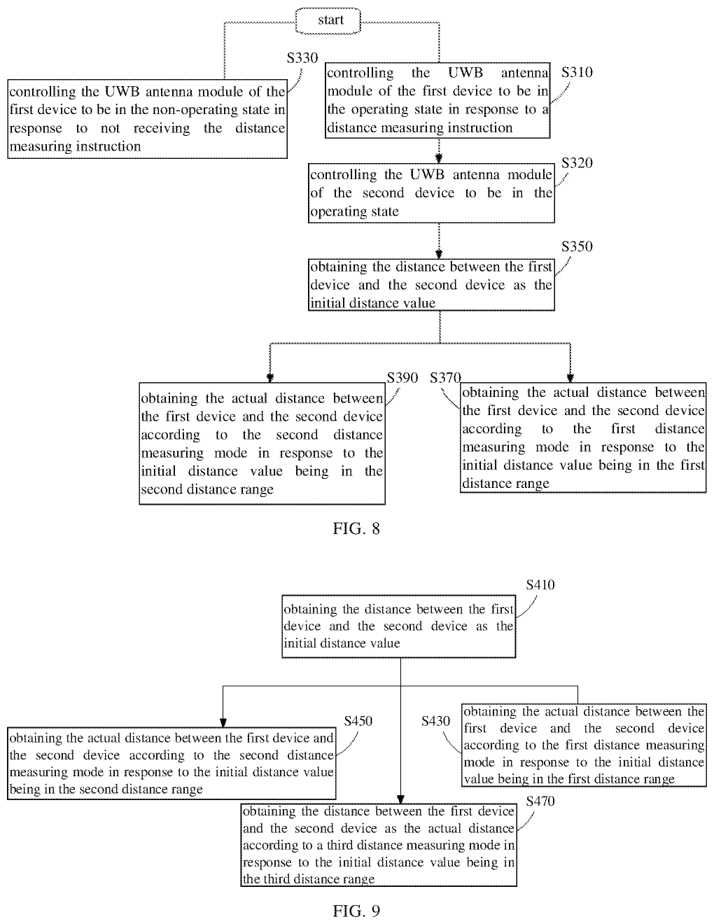

Based on the first device 100, the second device 200, and the distance measuring method provided by the above embodiments, the embodiment of the present disclosure further provides another distance measuring method. As illustrated in FIG. 8, the distance measuring method may include S310 to S390. The distance measuring method of the present embodiment has the same or corresponding implementation operations as those of the foregoing embodiments. For specific explanation of these same or corresponding implementation operations, reference may be made to the contents provided by the foregoing embodiments, which is not be repeated in the present embodiment.

At the operation S310, the distance measuring method may include controlling the UWB antenna module 400 of the first device 100 to be in the operating state in response to a distance measuring instruction.

The distance measuring instruction may be generated based on an input operation of the user. For example, the input operation includes an action, such as shaking, hand lifting, or the like. For example, the input operation includes voice, etc. In some embodiments, the state of the UWB antenna module 400 of the first device 100 is triggered by setting the distance measuring instruction, which helps to avoid that the UWB antenna module 400 in the operating state performs distance measuring due to misoperation, thereby avoiding causing the user to call out the distance measuring function in response to not requiring the distance measuring.

In some embodiments, before controlling the UWB antenna module 400 of the first device 100 to be in the operating state, the first device 100 may execute the operation of judging whether the distance measuring instruction is received or not, and may decide whether to execute the operation S310 or not according to the judgment result. For example, the first device 100 may judge that the distance measuring instruction is received according to the data of the processor of the first device 100, and directly execute the operation S310 and the operation S320. The operation S330 may be executed in response to judging that the distance measuring instruction is not received.

At the operation S330, the distance measuring method may include controlling the UWB antenna module 400 of the first device 100 to be in the non-operating state in response to not receiving the distance measuring instruction.

In the present embodiment, the UWB antenna module 400 of the first device 100 is controlled to be in the non-operating state in response to not receiving the distance measuring instruction. The power of the UWB antenna module 400 in the non-operating state is less than the power of the UWB antenna module 400 in the operating state, which helps the UWB antenna module 400 to be in the non-operating state in response to the user does not need to perform distance measuring, so as to save the power consumption. In the embodiments of the present disclosure, the UWB antenna module 400 is in the non-operating state, it is to be understood that the UWB antenna module 400 is in an off or standby state. In standby state, a radiation power of the UWB antenna module 400 is small or the UWB antenna module 400 does not radiate the signal. For example, the power of the UWB antenna module 400 waiting for wake-up in the standby state may be less than 0.1 microwatts, the power consumption may be less than 1 mA. The UWB antenna module 400 of the first device 100 is in the non-operating state, it may indicate that there is no need for distance measuring through the UWB antenna module 400 at this time. The UWB antenna module 400 of the second device 200 may also be controlled to be in the non-operating state. For example, in response to the UWB antenna module 400 of the first device 100 being in the non-operating state, the second device 200 may control the UWB antenna module 400 of the second device 200 to be in the non-operating state based on the UWB antenna module 400 of the first device 100 (for example, a control instruction is generated according to an operating state signal sent by the first device 100).

In the present embodiment, the state of the UWB antenna module 400 of the second device 200 is triggered according to the state of the UWB antenna module 400 of the first device 100, which helps the UWB antenna module 400 of the second device 200 to be in the non-operating state in response to the UWB antenna module 400 of the first device 100 being not in the operating state, so as to save the power consumption. The first device 100 may judge that the distance measuring instruction is received according to the data of the processor of the first device 100, and directly respond to the distance measuring instruction to control the UWB antenna module 400 of the first device 100 to be in the operating state (i.e., directly execute the operation S310). The operation S320 is also executed.

At the operation S320, the distance measuring method may include controlling the UWB antenna module 400 of the second device 200 to be in the operating state.

In the present embodiment, in response to the UWB antenna module 400 of the first device 100 being in the operating state, the UWB antenna module 400 of the second device 200 is controlled to be in the operating state. The state of the UWB antenna module 400 of the second device 200 is triggered according to the state of the UWB antenna module 400 of the first device 100, which helps the UWB antenna module 400 of the second device 200 to quickly respond to the signal of the UWB antenna module 400 of the first device 100 in response to the UWB antenna module 400 of the first device 100 being in the operating state (it may indicate that there is a need for distance measurement through the UWB antenna module 400 at this time).

At the operation S350, the distance measuring method may include obtaining the distance between the first device 100 and the second device 200 as the initial distance value.

At the operation S370, the distance measuring method may include obtaining the actual distance between the first device 100 and the second device 200 according to the first distance measuring mode in response to the initial distance value being in the first distance range.

At the operation S390, the distance measuring method may include obtaining the actual distance between the first device 100 and the second device 200 according to the second distance measuring mode in response to the initial distance value being in the second distance range.

In the present embodiment, the implementation of the operation S350 may refer to the above operation S10, the implementation of the operation S370 may refer to the above operation S30, and the implementation of the operation S390 may refer to the above operation S50 for details, which are not be repeated in the present embodiment.

In the present embodiment, a state of the UWB antenna module 400 of the first device 100 is triggered by setting the distance measuring instruction. On the one hand, it helps to avoid that the UWB antenna module 400 in the operating state performs distance measuring due to misoperation, thereby avoiding causing the user to call out the distance measuring function in response to not requiring the distance measuring. On the other hand, the UWB antenna module 400 of the first device 100 is controlled to be in the non-operating state in response to not receiving the distance measuring instruction, the power of the UWB antenna module 400 in the non-operating state is smaller than the power of the UWB antenna module 400 in the operating state, which helps the UWB antenna module 400 to be in the non-operating state in response to the user does not need to perform the distance measurement, so as to save the power consumption.

In the embodiments of the present disclosure, the operations S310 and S330 may be executed in no sequential order, and may be executed sequentially. The operations S310 and S350 may be executed in no sequential order, and may be executed sequentially or simultaneously. The operations S330 and S350 may be executed in no sequential order, and may be executed sequentially or simultaneously. It is not limited to the specific examples provided in the present specification and the accompanying drawings.

Based on the first device 100, the second device 200, and the distance measuring method provided by the above embodiments, the embodiment of the present disclosure further provides another distance measuring method. As illustrated in FGI. 9, the distance measuring method may include an operation S410, an operation S430, an operation S450, and an operation S470. The distance measuring method of the present embodiment has the same or corresponding implementation operations as those of the foregoing embodiments. For detailed explanation of the same or corresponding implementation operations, reference may be made to the contents provided by the foregoing embodiments, which is not repeated in the present embodiment.

At the operation S410, the distance measuring method may include obtaining the distance between the first device 100 and the second device 200 as the initial distance value.

At the operation S430, the distance measuring method may include obtaining the actual distance between the first device 100 and the second device 200 according to the first distance measuring mode in response to the initial distance value being in the first distance range.

At the operation S450, the distance measuring method may include obtaining the actual distance between the first device 100 and the second device 200 according to the second distance measuring mode in response to the initial distance value being in the second distance range.

In the present embodiment, the implementation of operation S410 may refer to the above operation S10, the implementation of operation S430 may refer to the above operation S30, and the implementation of operation S450 may refer to the above operation S50, which are not repeated in the present embodiment.

At the operation S470, the distance measuring method may include obtaining the distance between the first device 100 and the second device 200 as the actual distance according to a third distance measuring mode in response to the initial distance value being in the third distance range.

The third distance range may be set based on the specific distance measuring application. Any value in the third distance range may be greater than any value in the first distance range, and greater than any value in the second distance range. Further, in the present embodiment, the lower limit value of the second distance range is greater than the upper limit value of the first distance range, and an upper limit value of the second distance range is less than a lower limit value of the third distance range. For example, the third distance range may be [3, 10) meters, that is, a distance in the third distance range is greater than or equal to 3 meters, and less than 10 meters. The third distance range may also be other ranges, for example, a distance in the third distance range may be more than or equal to 3 meters.

In the present embodiment, the third distance measuring mode is that the distance between the first device 100 and the second device 200 is obtained based on the Bluetooth module 300. The first Bluetooth module 301 and the second Bluetooth module 302 may use a BLE technology to perform distance measuring. The first Bluetooth module 301 and the second Bluetooth module 302 may measure the distance between the first device 100 and the second device 200 based on RSSI of the Bluetooth signal transmitted between the first Bluetooth module 301 and the second Bluetooth module 302. An operating frequency band of the Bluetooth signal is lower than an operating frequency band of the UWB signal, thus the communication distance of the Bluetooth signal is farther. According to the embodiments of the disclosure, the flexibility of the distance measuring method is improved by adding the third distance measuring mode, so that the third distance measuring mode may be applied to a long-distance measuring scenario. Compared with the distance measuring performed by the UWB antenna module 400, the distance measuring performed by the Bluetooth module 300 may reduce the power consumption of the device.

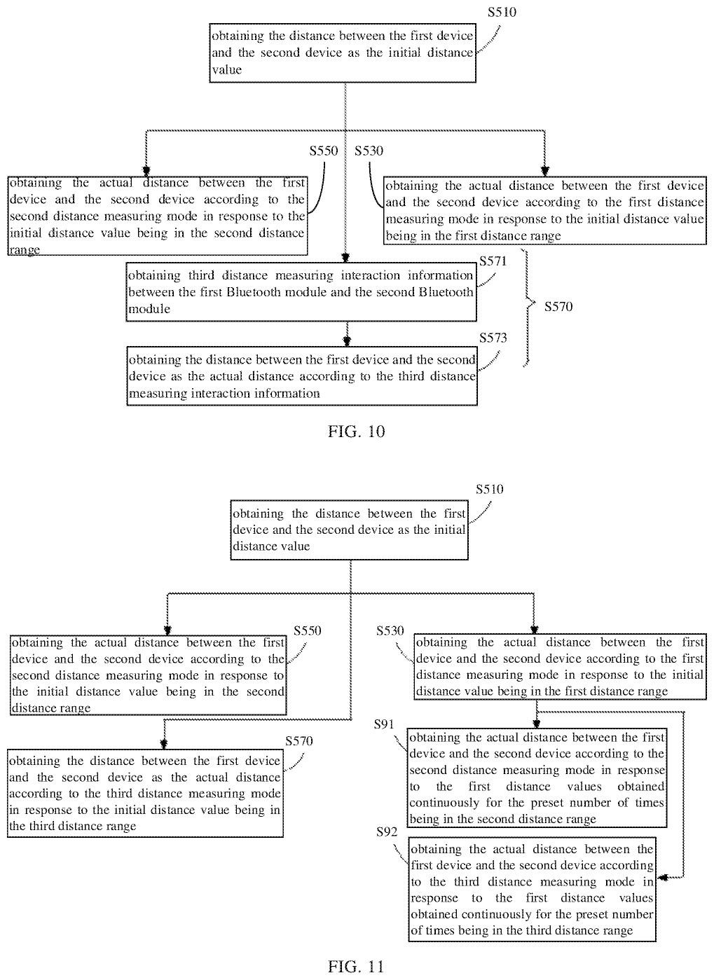

Based on the first device 100, the second device 200, and the distance measuring method provided by the above embodiments, the embodiment of the present disclosure further provides another distance measuring method. As illustrated in FIG. 10, the distance measuring method may include an operation S510, an operation S530, an operation S550, and an operation S570. The distance measuring method of the present embodiment has the same or corresponding implementation operations as those of the foregoing embodiments. For detailed explanation of the same or corresponding implementation operations, reference may be made to the contents provided by the foregoing embodiments, which is not be repeated in the present embodiment.

At the operation S510, the distance measuring method may include obtaining the distance between the first device 100 and the second device 200 as the initial distance value.

At the operation S530, the distance measuring method may include obtaining the actual distance between the first device 100 and the second device 200 according to the first distance measuring mode in response to the initial distance value being in the first distance range.

At the operation S550, the distance measuring method may include obtaining the actual distance between the first device 100 and the second device 200 according to the second distance measuring mode in response to the initial distance value being in the second distance range.

In the present embodiment, the implementation of operation S510 may refer to the above operation S10, the implementation of operation S530 may refer to the above operation S30, and the implementation of operation S550 may refer to the above operation S50, which are not repeated in the present embodiment.

At the operation S570, the distance measuring method may include obtaining the distance between the first device 100 and the second device 200 as the actual distance according to the third distance measuring mode in response to the initial distance value being in the third distance range.

The third distance range may be set based on the specific distance measuring application. Any value in the third distance range may be greater than any value in the first distance range, and greater than any value in the second distance range. Further, in the present embodiment, the lower limit value of the second distance range is greater than the upper limit value of the first distance range, and an upper limit value of the second distance range is less than a lower limit value of the third distance range. For example, the third distance range may be [3, 10) meters, that is, a distance in the third distance range is greater than or equal to 3 meters, and less than 10 meters. The third distance range may also be other ranges, for example, a distance in the third distance range may be more than or equal to 3 meters.

In the present embodiment, the third distance measuring mode is that the distance between the first device 100 and the second device 200 is obtained based on the Bluetooth module 300. The first Bluetooth module 301 and the second Bluetooth module 302 may use a BLE technology to perform distance measuring. The first Bluetooth module 301 and the second Bluetooth module 302 may measure the distance between the first device 100 and the second device 200 based on RSSI of the Bluetooth signal transmitted between the first Bluetooth module 301 and the second Bluetooth module 302. The operating frequency band of the Bluetooth signal is lower than the operating frequency band of the UWB signal, thus the communication distance of the Bluetooth signal is farther. According to the embodiments of the disclosure, the flexibility of the distance measuring method is improved by adding the third distance measuring mode, so that the third distance measuring mode may be applied to the long-distance measuring scenario. Compared with the distance measuring performed by the UWB antenna module 400, the distance measuring performed by the Bluetooth module 300 may reduce the power consumption of the device. In the present embodiment, the operation S570 may include an operation S571 and an operation S573.

At the operation S571, the distance measuring method may include obtaining third distance measuring interaction information between the first Bluetooth module 301 and the second Bluetooth module 302.

The third distance measuring interaction information may include strength information of the Bluetooth signal between the first Bluetooth module 301 and the second Bluetooth module 302.

In some embodiments, in order to obtain the third distance measuring interaction information, the operation S571 may include: sending a mode instruction for triggering the third distance measuring mode to the second device 200; obtaining the power information of a distance measuring Bluetooth signal transmitted by the second Bluetooth module 302 based on the mode instruction; and obtaining the strength information of the distance measuring Bluetooth signal received by the first Bluetooth module 301. The mode instruction may be sent out based on the first Bluetooth module 301 switching to the third distance measuring mode, so that the second Bluetooth module 302 may be quickly switched and adapted to the current distance measuring mode of the first Bluetooth module 301.

At the operation S573, the distance measuring method may include obtaining the distance between the first device 100 and the second device 200 as the actual distance according to the third distance measuring interaction information.

In the present embodiment, based on the power information and strength information, the distance between the first device 100 and the second device 200 is calculated and used as the actual distance. In some embodiments, the transmitting terminal of the second Bluetooth module 302 may send out the distance measuring Bluetooth signal, and the receiving terminal of the first Bluetooth module 301 may receive the distance measuring Bluetooth signal. The first Bluetooth module 301 may parse out the strength of the received distance measuring Bluetooth signal, i.e., the Received Signal Strength Indication (RSSI), from the distance measuring Bluetooth signal. The distance D between the first device 100 and the second device 200 may be calculated according to the first calculation formula and the second calculation formula.

In the present embodiment, the first Bluetooth module 301 and the second Bluetooth module 302 may measure the distance between the first device 100 and the second device 200 based on RSSI of the Bluetooth signal transmitted between the first Bluetooth module 301 and the second Bluetooth module 302. The operating frequency band of the Bluetooth signal is lower than the operating frequency band of the UWB signal, thus the communication distance of the Bluetooth signal is farther. According to the embodiments of the disclosure, the flexibility of the distance measuring method is improved by adding the third distance measuring mode, so that the third distance measuring mode may be applied to the long-distance measuring scenario. Compared with the distance measuring performed by the UWB antenna module 400, the distance measuring performed by the Bluetooth module 300 may reduce the power consumption of the device. In some embodiments, the distance that is obtained according to the first distance measuring mode may be used as the first distance value.

As illustrated in FIG. 11, in the present embodiment, in order to improve the accuracy of the distance measuring, the distance measuring method may further include an operation S91 and/or an operation S92.

At the operation S91, the distance measuring method may include obtaining the actual distance between the first device 100 and the second device 200 according to the second distance measuring mode in response to the first distance values obtained continuously for the preset number of times being in the second distance range.

The preset number of times may be fixed number of times, or the number of times that are individually set to the user (such as, 3 times, 5 times, 7 times, etc.). For example, the preset number of times are five times. In response to the first distance values obtained continuously for five times being in the second distance range, the first distance measuring mode is switched to the second distance measuring mode. The specific values of the preset number of times may also be other values. For example, in some specific scenarios, since the initial distance value is measured by using a Bluetooth low energy mode, the initial distance value may be a coarse estimate value. In response to the initial distance value being in the first distance range, which indicates that the actual distance between the first device 100 and the second device 200 is closer, and the first distance measuring mode with higher accuracy is needed for accurate measurement. That is, a TOF measurement mode of the UWB antenna module 400 is used. After using the first distance measuring mode for accurate measurement, it is found that the actual distance between the first device 100 and the second device 200 is actually in the second distance range (e.g., this is likely to occur in response to the actual distance being near the adjacent value of the second distance range and the first distance range). An operation of verifying distance measurement may be implemented. That is, five distances may be obtained by using the first distance measuring mode. In response to the five distances being in the second distance range, the distance measuring mode should be adjusted to the second distance measuring mode. That is, it is not necessary to adopt the TOF measurement mode of the UWB antenna module 400, but adopt RSSI measurement mode of the UWB antenna module 400.

In the present embodiment, on the one hand, the distance measuring mode is switched in response to the second distance measuring mode being more suitable for measuring the distance than the first distance measuring mode, so that switched second distance measuring mode may be better matched with the current distance. On the other hand, it helps to prevent switching back and forth between the distance measuring modes due to the first distance value being at a critical position, thereby ensuring the stability of distance measuring and avoiding frequent switching of the distance measuring modes. The frequent switching of the distance measuring modes is not beneficial to reducing the power consumption of the device.

At the operation S92, the distance measuring method may include obtaining the actual distance between the first device 100 and the second device 200 according to the third distance measuring mode in response to the first distance values obtained continuously for the preset number of times being in the third distance range.

In the present embodiment, on the one hand, the distance measuring mode is switched in response to the third distance measuring mode being more suitable for measuring the distance than the first distance measuring mode, so that switched third distance measuring mode may be better matched with the current distance. On the other hand, it helps to prevent switching back and forth between the distance measuring modes due to the first distance value being at a critical position, thereby ensuring the stability of distance measuring and avoiding frequent switching of the distance measuring modes. The frequent switching of the distance measuring modes is not beneficial to reducing the power consumption of the device. In some embodiments, the distance obtained by using the second distance measuring mode may be used as the second distance value.

In some embodiments, the distance measuring method may further include an operation S93, an operation S94, an operation S95, or an operation S96.

At the operation S93, the distance measuring method may include obtaining the actual distance between the first device 100 and the second device 200 according to the first distance measuring mode in response to the second distance values obtained continuously for the preset number of times being in the first distance range.

In the present embodiment, on the one hand, the distance measuring mode is switched in response to the first distance measuring mode being more suitable for measuring the distance than the second distance measuring mode, so that switched first distance measuring mode may be better matched with the current distance. On the other hand, it helps to prevent switching back and forth between the distance measuring modes due to the second distance value being at the critical position, thereby ensuring the stability of distance measuring and avoiding frequent switching of the distance measuring modes. The frequent switching of the distance measuring modes is not beneficial to reducing the power consumption of the device.

At the operation S94, the distance measuring method may include obtaining the actual distance between the first device 100 and the second device 200 according to the third distance measuring mode in response to the second distance values obtained continuously for the preset number of times being in the third distance range.

In the present embodiment, on the one hand, the distance measuring mode is switched in response to the third distance measuring mode being more suitable for measuring the distance than the second distance measuring mode, so that switched third distance measuring mode may be better matched with the current distance. On the other hand, it helps to prevent switching back and forth between the distance measuring modes due to the second distance value being at the critical position, thereby ensuring the stability of distance measuring and avoiding frequent switching of the distance measuring modes. The frequent switching of the distance measuring modes is not beneficial to reducing the power consumption of the device. In some embodiments, the distance obtained by using the third distance measuring mode may be used as the third distance value.

At the operation S95, the distance measuring method may include obtaining the actual distance between the first device 100 and the second device 200 according to the first distance measuring mode in response to the third distance values obtained continuously for the preset number of times being in the first distance range.

In the present embodiment, on the one hand, the distance measuring mode is switched in response to the first distance measuring mode being more suitable for measuring the distance than the third distance measuring mode, so that switched first distance measuring mode may be better matched with the current distance. On the other hand, it helps to prevent switching back and forth between the distance measuring modes due to the third distance value being at the critical position, thereby ensuring the stability of distance measuring and avoiding frequent switching of the distance measuring modes. The frequent switching of the distance measuring modes is not beneficial to reducing the power consumption of the device.

At the operation S96, the distance measuring method may include obtaining the actual distance between the first device 100 and the second device 200 according to the second distance measuring mode in response to the third distance values obtained continuously for the preset number of times being in the second distance range.

In the present embodiment, on the one hand, the distance measuring mode is switched in response to the second distance measuring mode being more suitable for measuring the distance than the third distance measuring mode, so that switched second distance measuring mode may be better matched with the current distance. On the other hand, it helps to prevent switching back and forth between the distance measuring modes due to the third distance value being at the critical position, thereby ensuring the stability of distance measuring and avoiding frequent switching of the distance measuring modes. The frequent switching of the distance measuring modes is not beneficial to reducing the power consumption of the device.

In some embodiments, based on the above-mentioned distance measuring method, after obtaining the actual distance between the first device 100 and the second device 200, the distance measuring mode may be stored based on the distance measuring mode that is used in measuring the actual distance, so as to enable that the distance measuring mode is directly used for next time distance measuring. Alternatively, after the initial distance between the first device 100 and the second device 200 is obtained, the distance measuring mode may be stored based on the distance measuring mode that is used in measuring the initial distance, so that the distance measuring mode may be directly used for next distance measuring. For example, after the operation S30, the operation S50 or the operation S570 of the above operations (or the corresponding operations of other embodiments), the distance measuring method provided by the present disclosure may further include the operation S97 and the operation S98.

At the operation S97, the distance measuring method may include taking a current distance measuring mode for obtaining the actual distance between the first device 100 and the second device 200 as a default distance measuring mode.

At the operation S98, the distance measuring method may include obtaining the actual distance between the first device 100 and the second device 200 according to the default distance measuring mode in response to the Bluetooth modules 300 or the UWB antenna modules 400 of the first device 100 and the second device 200 being in the operating state. The default distance measuring mode may be the first distance measuring mode, the second distance measuring mode, or the third distance measuring mode. In the present embodiment, the distance measuring mode for obtaining the distance between the first device 100 and the second device 200 is stored, so that an appropriate distance measuring mode may be quickly used in the next distance measuring.

In some embodiments, after the operation S97, the distance measuring method may further include an operation S99.

At the operation S99, the distance measuring method may include controlling the second device 200 to switch to the same distance measuring mode as the first device 100 in response to not using the default distance measuring mode by the first device 100. In the present embodiment, in response to not using the default distance measuring mode by the first device 100, the second device 200 may be quickly switched and adapted to the current distance measuring mode of the first device 100.

In some embodiments, after obtaining the actual distance between the first device 100 and the second device 200, the distance measuring method may further include an operation S100.

At the operation S100, the distance measuring method may include transmitting a mode determination signal to the second device 200 in response to a distance measuring mode determination instruction.

The distance measuring mode determination instruction is generated based on the initial distance and is used to determine the distance measuring mode for obtaining the actual distance. The distance measuring mode includes any one of the first distance measuring mode, the second distance measuring mode, and the third distance measuring mode. The first device 100 and the second device 200 may be switched for distance measuring in the first distance measuring mode, the second distance measuring mode, and the third distance measuring mode. Thus, in response to the current distance measuring mode (or the default distance measuring mode) being not suitable for the current distance measuring requirement, the distance measuring mode may be switched.

In a specific disclosure scenario, after the initial distance value is obtained, the distance measuring mode to be adopted may be determined according to the initial distance value. At this time, it may be considered that the mode determination instruction is generated or received. Further, in response to the current distance measuring mode being different from the distance measuring mode corresponding to the initial distance value, it indicates that there is a need to switch the distance measuring mode. At this time, both the first device 100 and the second device 200 should adjust operating parameters to jointly use the distance measuring mode corresponding to the initial distance value to perform distance measuring. The current distance measuring mode should be understood as the distance measuring mode that is adopted or defaulted before obtaining the actual distance between the first device 100 and the second device 200, which may be the default distance measuring mode obtained in the operation S97.

In another specific disclosure scenario, for example, in the above operations S91 to S96, the obtained actual distance is reviewed and confirmed, to improve the accuracy of distance measurement. In response to the first distance value obtained during the review and confirmation (i.e., the distance value obtained based on the first distance measuring mode) being in the second distance range (corresponding to the second distance measuring mode), the first distance measuring mode is not suitable for the current distance measuring. It may be characterized as receiving or generating the distance measuring mode determination instruction, and the distance measuring mode determination instruction is configured to determine that the second distance measuring mode is about to be used for distance measuring. For example, in response to the first distance value obtained in the review and confirmation (i.e., the distance value obtained based on the first distance measuring mode) being in the third distance range (corresponding to the third distance measuring mode), the first distance measuring mode is not suitable for the current distance measuring. It may be characterized as receiving or generating the distance measuring mode determination instruction, and the distance measuring mode determination instruction is configured to determine that the third distance measuring mode is about to be used for distance measuring. For example, the second distance value obtained in the review and confirmation is in the first distance range or the third distance range. For example, the third distance value obtained in the review and confirmation is in the first distance range or the second distance range. It may indicate that the currently obtained distance value is not in the corresponding distance range, and the distance measuring mode should be updated, which may indicate that the distance measuring mode determination instruction is received.

The mode determination signal is configured to trigger the second device 200 to adjust the operating parameter according to the distance measuring mode. The first device 100 adjusts the operating parameters after determining the signal in a transmission mode, which not only helps the first device 100 with adjusted operating parameters to measure the distance based on the same distance measuring mode as the second device 200 with adjusted operating parameters, but also ensures that the mode determination signal sent by the first device 100 may be received by the second device 200, so as to avoid that the first device 100 and the second device 200 may not perform the signal interaction due to different distance measuring modes.

In some cases, the mode determination signal may be considered as a mode “switch” signal. For example, in response to the distance measuring mode determined by the first device 100 based on the initial distance being different from the default distance measuring mode, the first device 100 should send the mode determination signal to the second device 200. The second device 200 may obtain the distance measuring mode to be used based on the mode determination signal, transmit the Bluetooth signal according to the distance measuring mode to be used (e.g., the third distance measuring mode), or transmit the UWB signal without the time stamp information (such as the first distance measuring mode), or transmit the UWB signal with the time stamp information to interact with the first device 100 (such as the second distance measuring mode), so as to cooperate with the first device 100 to use the corresponding distance measuring mode to complete distance measuring.

The distance measuring method provided by the embodiments of the present disclosure is configured to measure the distance between the first device 100 and the second device 200. Each of the first device 100 and the second device 200 includes the Bluetooth module 300 and the UWB antenna module 400. In response to the initial distance value being in the first distance range, the actual distance between the first device 100 and the second device 200 may be obtained according to the first distance measuring mode. In response to the initial distance value being in the second distance range, the actual distance between the first device 100 and the second device 200 may be obtained according to the second distance measuring mode. In the second distance measuring mode and the first distance measuring mode, the actual distance between the first device 100 and the second device 200 is obtained based on the UWB antenna module 400, which helps to perform the secondary distance measuring through the UWB antenna module 400. Compared with the distance measuring performed by the Bluetooth module 300, the distance measuring performed by the UWB antenna module 400 has the advantages that the anti-interference capability is stronger, and the accuracy of the obtained actual distance is higher. The power consumption of the second distance measuring mode is lower than the power consumption of the first distance measuring mode, and the second distance range has no intersection with the first distance range, which helps to adopt different distance measuring modes in different distance ranges according to the initial distance value, so that the mode adopted by the secondary distance measuring is more flexible.

As illustrated in FIG. 12, based on the above-mentioned distance measuring method, the embodiment of the present disclosure further provides a distance measuring apparatus 1000. The distance measuring apparatus 1000 is configured to measure the distance between the first device 100 and the second device 200, and each of the first device 100 and the second device 200 includes the UWB antenna module 400. The distance measuring apparatus 1000 includes an initial distance measuring module 501, a first distance measuring module 502, and a second distance measuring module 503. The initial distance measuring module 501 is configured to obtain the distance between the first device 100 and the second device 200 as the initial distance value. The first distance measuring module 502 is configured to obtain the actual distance between the first device 100 and the second device 200 according to the first distance measuring mode in response to the initial distance value being in the first distance range. The second distance measuring module 503 is configured to obtain the actual distance between the first device 100 and the second device 200 according to the second distance measuring mode in response to the initial distance value being in the second distance range. In the second distance measuring mode and the first distance measuring mode, the actual distance between the first device 100 and the second device 200 is obtained based on the UWB antenna module 400. The power consumption of the second distance measuring mode is lower than the power consumption of the first distance measuring mode, and there is no intersection between the second distance range and the first distance range.

The initial distance measuring module 501 may be further configured to obtain the distance between the first device 100 and the second device 200 as the initial distance value based on the signal transmitted between the first device 100 and the second device 200.

The initial distance measuring module 501 may be further configured to send the trigger signal to the second device 200 based on the Bluetooth module 300. The trigger signal is configured to trigger the second device 200 to send the distance measuring feedback signal, and determine the distance between the first device 100 and the second device 200 as the initial distance value according to the strength of the distance measuring feedback signal received by the first device 100.

The initial distance measuring module 501 may be further configured to send the trigger signal to the second device 200 based on the UWB antenna module 400 of the first device 100, wherein the trigger signal is configured to trigger the second device 200 to send the distance measuring UWB feedback signal; and determine the distance between the first device 100 and the second device 200 as the initial distance value according to the signal strength of the distance measuring UWB feedback signal.

The first distance measuring module 502 may be further configured to control the UWB antenna module 400 of the first device 100 to be in the operating state in response to the distance measuring instruction; and control the UWB antenna module 400 of the first device 100 to be in the non-operating state in response to not receiving the distance measuring instruction, wherein the power of the UWB antenna module 400 in the non-operating state is smaller than the power of the UWB antenna module 400 in the operating state.

The first distance measuring module 502 may be further configured to control the UWB antenna module 400 of the second device 200 to be in the non-operating state in response to the UWB antenna module 400 of the first device 100 being not in the operating state.

The first distance measuring module 502 may be further configured to obtain the first distance measuring interaction information of the first UWB antenna module 401 and the second UWB antenna module 402, wherein the first distance measuring interaction information includes the time information of UWB signal interaction between the first UWB antenna module 401 and the second UWB antenna module 402; and obtain the actual distance between the first device 100 and the second device 200 according to the first distance measuring interaction information.

The first distance measuring module 502 may be further configured to control the first UWB antenna module 401 to send the distance measuring UWB signal, and obtain the sending time information of the distance measuring UWB signal; obtain the arrival time information of the distance measuring UWB signal to the second UWB antenna module 402; obtain the feedback time information of the feedback UWB signal sent by the second UWB antenna module 402 according to the distance measuring UWB signal; and obtain the receiving time information of the feedback UWB signal received by the first UWB antenna module 401.

The first distance measuring module 502 may be further configured to calculate the actual distance between the first device 100 and the second device 200 according to the distance measuring time information, the arrival time information, the feedback time information, and the receiving time information.

The second distance measuring module 503 may be further configured to obtain the second distance measuring interaction information of the first UWB antenna module 401 and the second UWB antenna module 402, wherein the second distance measuring interaction information includes the strength information of the UWB signals between the first UWB antenna module 401 and the second UWB antenna module 402; and obtain the actual distance between the first device 100 and the second device 200 according to the second distance measuring interaction information.

The second distance measuring module 503 may be further configured to send the mode instruction for triggering the second distance measuring mode to the second device 200; obtain the power information of the distance measuring UWB signal sent by the second UWB antenna module 402 based on the mode instruction; and obtain the strength information of the distance measuring UWB signal received by the first UWB antenna module 401.

The second distance measuring module 503 may be further configured to calculate the actual distance between the first device 100 and the second device 200 based on the power information and the strength information.

The distance measuring apparatus 1000 may further include an instruction module. The instruction module may be configured to control the UWB antenna module 400 of the first device 100 to be in the operating state in response to receiving the distance measuring instruction; and control the UWB antenna module 400 of the first device 100 to be in the non-operating state in response to not receiving the distance measuring instruction. The power of the UWB antenna module 400 in the non-operating state is smaller than the power of the UWB antenna module 400 in the operating state.

The distance measuring apparatus 1000 may further includes a third distance measuring module. The third distance measuring module is configured to obtain the distance between the first device 100 and the second device 200 according to the third distance measuring mode in response to the initial distance value being in the third distance range. The third distance measuring mode obtains the distance between the first device 100 and the second device 200 based on the Bluetooth module 300, and any value in the third distance range is greater than any value in the first distance range, and greater than any value in the second distance range.

The second distance measuring module 503 may be further configured to send the mode instruction for triggering the third distance measuring mode to the second device 200; obtain the power information of the distance measuring Bluetooth signal sent by the second Bluetooth module 302 based on the mode instruction; obtain the strength information of the distance measuring Bluetooth signal received by the first Bluetooth module 301; and calculate the distance between the first device 100 and the second device 200 as the actual distance based on the power information and the strength information.

The distance measuring apparatus 1000 may further include a mode switching module. The mode switching module may be configured to obtain the actual distance between the first device 100 and the second device 200 according to the second distance measuring mode in response to the first distance values obtained continuously for the preset number of times being in the second distance range.

The mode switching module may be further configured to obtain the actual distance between the first device 100 and the second device 200 according to the third distance measuring mode in response to the first distance values obtained continuously for the preset number of times being in the third distance range.

The mode switching module may be further configured to obtain the actual distance between the first device 100 and the second device 200 according to the first distance measuring mode in response to the second distance values obtained continuously for the preset number of times being in the first distance range.

The mode switching module may be further configured to obtain the actual distance between the first device 100 and the second device 200 according to the third distance measuring mode in response to the second distance values obtained continuously for the preset number of times being in the third distance range.

The mode switching module may be further configured to obtain the actual distance between the first device 100 and the second device 200 according to the first distance measuring mode in response to the third distance values obtained continuously for the preset number of times being in the first distance range.

The mode switching module may be further configured to obtain the actual distance between the first device 100 and the second device 200 according to the second distance measuring mode in response to the third distance values obtained continuously for the preset number of times being in the second distance range.

The distance measuring device 1000 may further include a mode confirmation module. The mode confirmation module may be configured to transmit the mode determination signal to the second device 200 in response to the distance measuring mode determination instruction. The distance measuring mode determination instruction is generated based on the initial distance and configured to determine the distance measuring mode for obtaining the actual distance. The distance measuring mode includes the first distance measuring mode, the second distance measuring mode, and the third distance measuring mode. The mode determination signal is configured to trigger the second device 200 to adjust the operating parameter according to the distance measuring mode.

The distance measuring apparatus 1000 may further include a default distance measuring module. The default distance measuring module may be configured to use the currently obtained distance measuring mode for obtaining the distance between the first device 100 and the second device 200 as the default distance measuring mode. In response to the Bluetooth modules 300 or the UWB antenna modules 400 of the first device 100 and the second device 200 being in the operating state, the distance between the first device 100 and the second device 200 is obtained according to the default distance measuring mode.

The mode switching module may be further configured to control the second device 200 to switch to the same distance measuring mode as the first device 100 in response to not adopting the default distance measuring mode by the first device 100.

As illustrated in FIG. 13, the embodiment of the present disclosure further provides an electronic device 2000. The electronic device 2000 includes a memory 87 and a processor 82. The memory 87 is configured to store program instructions. The memory 87 and the processor 82 are connected through an input/output (IO) bus 86 to interact with each other. In response to executing the program instructions by the processor 82, the processor 82 executes the distance measuring method according to any one of the foregoing embodiments.

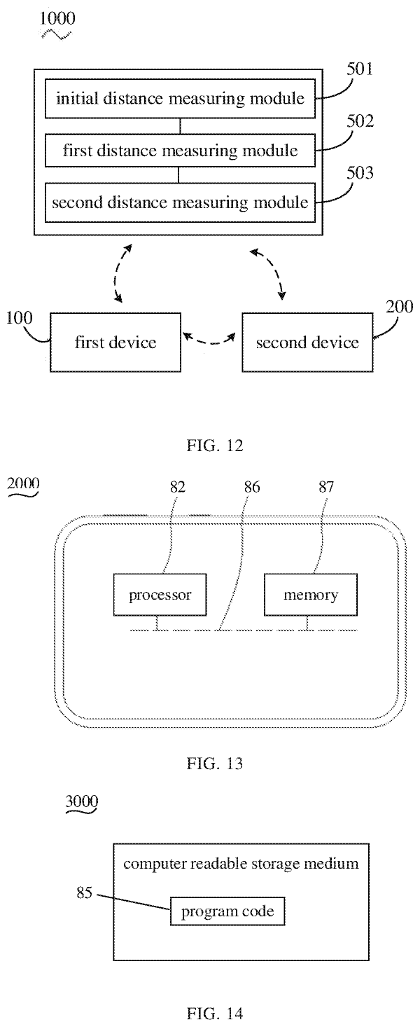

As illustrated in FIG. 14, the embodiment of the present disclosure further provides a non-transitory computer readable storage medium 3000, a program code 85 is stored in the non-transitory computer readable storage medium 3000. The program code 85 may be configured to be called by the processor 82 to execute the distance measuring method according to any one of the foregoing embodiments.

The distance measuring method, the distance measuring apparatus, the electronic device, and the non-transitory computer readable storage medium provided by the embodiments of the present disclosure are configured to measure the distance between the first device 100 and the second device 200. Each of the first device 100 and the second device 200 includes the UWB antenna module 400. The distance between the first device 100 and the second device 200 may be obtained according to the first distance measuring mode in response to the initial distance value being in the first distance range. In response to the initial distance value being in the second distance range, the distance between the first device 100 and the second device 200 may be obtained according to the second distance measuring mode. In the second distance measuring mode and the first distance measuring mode, the distance between the first device 100 and the second device 200 is obtained based on the UWB antenna module 400, which helps to perform secondary distance measuring through the UWB antenna module 400. Compared with the distance measuring performed by the Bluetooth module 300, the distance measuring performed by the UWB antenna module 400 has the advantages that the anti-interference capability is stronger, and the accuracy of the obtained actual distance is higher. The power consumption of the second distance measuring mode is lower than the power consumption of the first distance measuring mode, and the second distance range has no intersection with the first distance range, which helps to adopt different distance measuring modes in different distance ranges according to the initial distance value, so that the mode adopted by the secondary distance measuring is more flexible.

The distance measuring method, the distance measuring apparatus, the electronic device, and the non-transitory computer readable storage medium provided by the embodiments of the present disclosure are configured to measure the distance between the first device and the second device. Each of the first device and the second device includes the UWB antenna module. The actual distance between the first device and the second device may be obtained according to the first distance measuring mode in response to the initial distance value being in the first distance range. In response to the initial distance value being in the second distance range, the actual distance between the first device and the second device may be obtained according to the second distance measuring mode. In the second distance measuring mode and the first distance measuring mode, the distance between the first device and the second device is obtained as the actual distance based on the UWB antenna module, which helps to perform secondary distance measuring through the UWB antenna module. Compared with the distance measuring performed by the Bluetooth module, the distance measuring performed by the UWB antenna module has the advantages that the anti-interference capability is stronger, and the accuracy of the obtained actual distance is higher. The power consumption of the second distance measuring mode is lower than that of the first distance measuring mode, and the second distance range has no intersection with the first distance range, which helps to adopt different distance measuring modes in different distance ranges according to the initial distance value, so that the mode adopted by the secondary distance measuring is more flexible.

In the present specification, the particular features or characteristics described may be combined in any suitable manner in any one or more embodiments or examples. In addition, without mutual contradiction, those of skilled in the art may combine the different embodiments or examples and the features of the different embodiments or examples described in the specification. Finally, it should be noted that the above embodiments are only used to illustrate the technical solutions of the present disclosure, but not to limit the technical solutions. Although the present disclosure has been described in detail with reference to the foregoing embodiments, those of ordinary skill in the art will understand that the technical solutions described in the foregoing embodiments may still be modified or some of the technical features may be equivalently replaced. However, these modifications or replacements do not drive the essence of the corresponding technical solutions to depart from the spirit and scope of the technical solutions of the embodiments of the present disclosure.

What is claimed is:

1. A distance measuring method, applied to measure a distance between a first device and a second device, each of the first device and the second device comprises a UWB antenna module, and the distance measuring method comprises:
obtaining the distance between the first device and the second device as an initial distance value;
obtaining an actual distance between the first device and the second device according to a first distance measuring mode in response to the initial distance value being in a first distance range; and
obtaining the actual distance between the first device and the second device according to a second distance measuring mode in response to the initial distance value being in a second distance range, wherein the second distance measuring mode and the first distance measuring mode are both configured to obtain the actual distance between the first device and the second device based on the UWB antenna module, power consumption of the second distance measuring mode is lower than that of the first distance measuring mode, and no intersection exist between the second distance range and the first distance range.

2. The distance measuring method according to claim 1, wherein before the obtaining the actual distance between the first device and the second device, the distance measuring method further comprises:
controlling the UWB antenna module of the first device to be in an operating state in response to a distance measuring instruction; and
controlling the UWB antenna module of the first device to be in a non-operating state in response to not receiving the distance measuring instruction, wherein power of the UWB antenna module in the non-operating state is smaller than that of the UWB antenna module in the operating state.

3. The distance measuring method according to claim 1, wherein the obtaining the distance between the first device and the second device as an initial distance value, comprises:
obtaining the distance between the first device and the second device as the initial distance value based on a signal transmitted between the first device and the second device.

4. The distance measuring method according to claim 3, wherein the obtaining the distance between the first device and the second device as the initial distance value based on a signal transmitted between the first device and the second device, comprises:
sending a trigger signal to the second device based on the UWB antenna module of the first device, wherein the trigger signal is configured to trigger the second device to send a distance measuring UWB feedback signal; and
determining the distance between the first device and the second device as the initial distance value according to signal strength of the distance measuring UWB feedback signal.

5. The distance measuring method according to claim 3, wherein each of the first device and the second device comprise a Bluetooth module; and the obtaining the distance between the first device and the second device as the initial distance value based on a signal transmitted between the first device and the second device, comprises:
sending a trigger signal to the second device based on the Bluetooth module, wherein the trigger signal is configured to trigger the second device to send a distance measuring feedback signal; and
determining the distance between the first device and the second device as the initial distance value according to strength of the distance measuring feedback signal received by the first device.

6. The distance measuring method according to claim 1, wherein the first device comprises a first UWB antenna module, and the second device comprises a second UWB antenna module; and the obtaining an actual distance between the first device and the second device according to a first distance measuring mode, comprises:
obtaining first distance measuring interaction information of the first UWB antenna module and the second UWB antenna module, wherein the first distance measuring interaction information comprises time information of a UWB signal interaction between the first UWB antenna module and the second UWB antenna module; and
obtaining the actual distance between the first device and the second device according to the first distance measuring interaction information.

7. The distance measuring method according to claim 6, wherein the obtaining first distance measuring interaction information of the first UWB antenna module and the second UWB antenna module, comprises:
controlling the first UWB antenna module to send a distance measuring UWB signal, and obtaining sending time information of the distance measuring UWB signal;
obtaining arrival time information of the distance measuring UWB signal to the second UWB antenna module;
obtaining feedback time information of a feedback UWB signal sent by the second UWB antenna module according to the distance measuring UWB signal; and
obtaining receiving time information of the feedback UWB signal received by the first UWB antenna module; and
the obtaining the actual distance between the first device and the second device according to the first distance measuring interaction information, comprises: calculating the actual distance between the first device and the second device according to the sending time information, the arrival time information, the feedback time information and the receiving time information.

8. The distance measuring method according to claim 1, wherein the first device comprises a first UWB antenna module, and the second device comprises a second UWB antenna module; and the obtaining the actual distance between the first device and the second device according to a second distance measuring mode, comprises:
obtaining second distance measuring interaction information of the first UWB antenna module and the second UWB antenna module, wherein the second distance measuring interaction information comprises strength information of a UWB signal between the first UWB antenna module and the second UWB antenna module; and
obtaining the actual distance between the first device and the second device according to the second distance measuring interaction information.

9. The distance measuring method according to claim 8, wherein the obtaining second distance measuring interaction information of the first UWB antenna module and the second UWB antenna module, comprises:
sending a mode instruction to the second device, wherein the mode instruction is configured to trigger the second distance measuring mode;
obtaining power information of a distance measuring UWB signal sent by the second UWB antenna module based on the mode instruction; and
obtaining strength information of the distance measuring UWB signal received by the first UWB antenna module; and
the obtaining the actual distance between the first device and the second device according to the second distance measuring interaction information, comprises: calculating the actual distance between the first device and the second device according to the power information and the strength information.

10. The distance measuring method according to claim 1, wherein a distance obtained by using the first distance measuring mode is used as a first distance value, a distance obtained by using the second distance measuring mode is used as a second distance value, and the distance measuring method further comprises:
obtaining the actual distance between the first device and the second device according to the second distance measuring mode in response to the first distance values obtained continuously for the preset number of times being in the second distance range; and
obtaining the actual distance between the first device and the second device according to the first distance measuring mode in response to the second distance values obtained continuously for the preset number of times being in the first distance range.

11. The distance measuring method according to claim 1, wherein each of the first device and the second device comprises a Bluetooth module, the distance measuring method further comprises:
obtaining the actual distance between the first device and the second device according to a third distance measuring mode in response to the initial distance value being in a third distance range, wherein in the third distance measuring mode, the distance between the first device and the second device is obtained based on the Bluetooth module and used as the actual distance; and any value in the third distance range is greater than any value in the first distance range and greater than any value in the second distance range.

12. The distance measuring method according to claim 11, wherein after obtaining the actual distance between the first device and the second device, the distance measuring method further comprises:
transmitting a mode determination signal to the second device in response to a distance measuring mode determination instruction, wherein the distance measuring mode determination instruction is generated based on the initial distance value and is configured to determine a distance measuring mode for obtaining the actual distance; the distance measuring mode comprises any one of the first distance measuring mode, the second distance measuring mode, and the third distance measuring mode; and the mode determination signal is configured to trigger the second device to adjust an operating parameter according to the distance measuring mode.

13. The distance measuring method according to claim 11, wherein the first device comprises a first Bluetooth module, and the second device comprises a second Bluetooth module; and the obtaining the actual distance between the first device and the second device according to a third distance measuring mode, comprises:
obtaining third distance measuring interaction information between the first Bluetooth module and the second Bluetooth module; and
obtaining the actual distance between the first device and the second device according to the third distance measuring interaction information.

14. The distance measuring method according to claim 13, wherein the obtaining third distance measuring interaction information between the first Bluetooth module and the second Bluetooth module, comprises:
sending a mode instruction to the second device, wherein the mode instruction is configured to trigger the third distance measuring mode;
obtaining power information of a distance measuring Bluetooth signal transmitted by the second Bluetooth module based on the mode instruction; and
obtaining strength information of the distance measuring Bluetooth signal received by the first Bluetooth module; and
the obtaining the actual distance between the first device and the second device according to the third distance measuring interaction information, comprises: calculating the actual distance between the first device and the second device according to the power information and the strength information.

15. The distance measuring method according to claim 11, wherein a distance obtained by using the first distance measuring mode is used as a first distance value, and the distance measuring method further comprises:
obtaining the actual distance between the first device and the second device according to the third distance measuring mode in response to the first distance value obtained continuously for preset number of times being in the third distance range.

16. The distance measuring method according to claim 11, wherein a distance obtained by using the second distance measuring mode is used as a second distance value, and the distance measuring method further comprises:
obtaining the actual distance between the first device and the second device according to the third distance measuring mode in response to the second distance value obtained continuously for preset number of times being in the third distance range.

17. The distance measuring method according to claim 11, wherein the distance obtained by using the third distance measuring mode is used as a third distance value, and the distance measuring method further comprises:
obtaining the actual distance between the first device and the second device according to the first distance measuring mode in response to the third distance values obtained continuously for preset number of times being in the first distance range; and
obtaining the actual distance between the first device and the second device according to the second distance measuring mode in response to the third distance values obtained continuously for preset times being in the second distance range.

18. An electronic device, comprising:
a memory storing program instructions; and
a processor, configured to perform a distance measuring method in response to executing the program instructions by the processor; wherein the distance measuring method is applied to measure a distance between a first device and a second device, each of the first device and the second device comprises a UWB antenna module, and the distance measuring method comprises:
obtaining the distance between the first device and the second device as an initial distance value;
obtaining an actual distance between the first device and the second device according to a first distance measuring mode in response to the initial distance value being in a first distance range; and
obtaining the actual distance between the first device and the second device according to a second distance measuring mode in response to the initial distance value being in a second distance range, wherein the second distance measuring mode and the first distance measuring mode are both configured to obtain the actual distance between the first device and the second device based on the UWB antenna module, power consumption of the second distance measuring mode is lower than that of the first distance measuring mode, and no intersection exist between the second distance range and the first distance range.

19. The electronic device according to claim 18, wherein before the obtaining the actual distance between the first device and the second device, the distance measuring method further comprises:
controlling the UWB antenna module of the first device to be in an operating state in response to a distance measuring instruction; and
controlling the UWB antenna module of the first device to be in a non-operating state in response to not receiving the distance measuring instruction, wherein power of the UWB antenna module in the non-operating state is smaller than that of the UWB antenna module in the operating state.

20. A non-transitory computer readable storage medium, wherein a program code is stored in the non-transitory computer readable storage medium, and the program code is configured to be called by a processor to execute a distance measuring method, the distance measuring method is applied to measure a distance between a first device and a second device, each of the first device and the second device comprises a UWB antenna module, and the distance measuring method comprises:
obtaining the distance between the first device and the second device as an initial distance value;
obtaining an actual distance between the first device and the second device according to a first distance measuring mode in response to the initial distance value being in a first distance range; and
obtaining the actual distance between the first device and the second device according to a second distance measuring mode in response to the initial distance value being in a second distance range, wherein the second distance measuring mode and the first distance measuring mode are both configured to obtain the actual distance between the first device and the second device based on the UWB antenna module, power consumption of the second distance measuring mode is lower than that of the first distance measuring mode, and no intersection exist between the second distance range and the first distance range.
